(19) United States
(12) Patent Application Publication
(10) Pub. No.: US 2016/0327048 A1
(43) Pub. Date: Nov. 10, 2016

(54) APPLIANCE PUMP ASSEMBLY

(71) Applicant: General Electric Company, Schenectady, NY (US)

(72) Inventor: Hanping Xu, Louisville, KY (US)

(21) Appl. No.: 14/706,341

(22) Filed: May 7, 2015

(51) Int. Cl. F04D 13/06; A47L 15/42

(52) U.S. Cl. CPC F04D 13/06; A47L 15/4225; B33Y 10/00

(57) ABSTRACT

A pump assembly for an appliance, an appliance, and a dishwasher appliance are provided. The pump assembly has features for isolating the noise of a pump of the assembly, including a unitary pump housing comprising structural layer and an acoustic layer. The appliance includes a pump assembly and features for isolating noise from a pump of the assembly without requiring insulation for a substantial portion of the appliance. The dishwasher appliance includes a pump assembly and features for isolating the noise of a pump of the assembly such that a substantial portion of the dishwasher appliance need not be insulated to isolate the pump noise.

### FIELD OF THE INVENTION

The subject matter of the present disclosure relates generally to appliances, such as dishwasher appliances, and more particularly to pump assemblies for use in such appliances.

### BACKGROUND OF THE INVENTION

Many appliances utilize fluids for various purposes, such as cleaning purposes, fluid supply purposes, etc. Dishwashers, washing machines, and refrigerators are examples of such appliances. Such appliances typically include conduits for flowing fluids therethrough, both for use in the appliance and for drainage from the appliance. Additionally, pumps may be utilized to encourage fluid flow through such conduits.

A dishwasher appliance, for example, typically includes at least one pump for flowing fluid through various conduits of the dishwasher appliance. Usually, dishwasher appliances include a pump for flowing fluid through a circulation pipe and a pump for flowing fluid through a drain pipe. The circulation pipe circulates fluid from a sump of the dishwasher appliance to spray assemblies which direct the fluid towards articles within the dishwasher appliance to clean such articles. The drain pipe drains fluid from the dishwasher appliance.

Known pumps utilized with appliances to encourage fluid flow through appliance conduits typically include an impeller positioned within a housing through which the fluid is flowed and a motor positioned outside of the housing. The conduit is in fluid communication with the housing, such that the fluid is encouraged through the conduit by the impeller. Typical appliance pumps are noisy and, in appliances such as dishwashers, are often the main source of noise for the appliance. Commonly, the entire appliance is insulated with one or more sound pack materials to reduce the pump noise, which can be costly. Eliminating such insulation could reduce the manufacturing time and expense of the appliance.

Accordingly, a pump assembly with one or more features for isolating the noise of a pump would be useful. An appliance having a pump assembly with one or more features for isolating the noise of a pump of the appliance without insulating a substantial portion of the appliance also would be beneficial.

### BRIEF DESCRIPTION OF THE INVENTION

The present invention provides a pump assembly for an appliance, an appliance, and a dishwasher appliance. The pump assembly has features for isolating the noise of a pump of the assembly, including a unitary pump housing comprising structural layer and an acoustic layer. The appliance includes a pump assembly and features for isolating noise from a pump of the assembly without requiring insulation for a substantial portion of the appliance. The dishwasher appliance includes a pump assembly and features for isolating the noise of a pump of the assembly such that a substantial portion of the dishwasher appliance need not be insulated to isolate the pump noise. Additional aspects and advantages of the invention will be set forth in part in the following description, or may be apparent from the description, or may be learned through practice of the invention.

In a first exemplary embodiment, a pump assembly for an appliance is provided. The pump assembly includes an impeller; a motor connected to the impeller and operable to rotate the impeller; and a unitary pump housing including a structural layer and an acoustic layer. The unitary pump housing is integrally formed of a continuous piece of material such that the structural layer and the acoustic layer are integrally formed of the continuous piece of material. The unitary pump housing defines a motor portion surrounding the motor and an impeller portion surrounding the impeller. The structural layer of the unitary pump housing is formed inward of the acoustic layer and is adjacent the impeller and motor.

In a second exemplary embodiment, a method for forming a unitary pump housing of an appliance is provided. The method comprises establishing three-dimensional information of the unitary pump housing; converting the three-dimensional information of the unitary pump housing from the established three-dimensional information into a plurality of slices, each slice of the plurality of slices defining a respective cross-sectional segment of the unitary pump housing; and successively forming each cross-sectional segment of the unitary pump housing with an additive process. After each cross-sectional segment is successively formed, the unitary pump housing is formed such that (1) the unitary pump housing is integrally formed of a structural layer and an acoustic layer and (2) the unitary pump housing defines a motor portion and an impeller portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front elevation view of a dishwasher appliance according to an exemplary embodiment of the present subject matter.

FIG. 2 provides a partial side section view of the exemplary dishwasher appliance of FIG. 1.

FIG. 3 provides a schematic cross-section view of an appliance according to an exemplary embodiment of the present subject matter.

FIG. 4 provides a schematic cross-section view of a portion of a unitary pump housing of the pump assembly of FIG. 3 according to an exemplary embodiment of the present subject matter.

FIG. 5 provides a chart illustrating a method for forming a unitary pump housing of an appliance according to an exemplary embodiment of the present subject matter.

Use of identical reference numerals in different figures denotes the same or similar components or features.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to, but need not be limited to, dishes, pots, pans, silverware, and other cooking utensils and items that can be cleaned in a dishwashing appliance. The term “wash cycle” is intended to refer to one or more periods of time during the cleaning process where a dishwashing appliance operates while containing articles to be washed and, preferably with agitation, uses a detergent and water to, e.g., remove soil particles including food and other undesirable elements from the articles. The term “rinse cycle” is intended to refer to one or more periods of time during the cleaning process in which the dishwashing appliance operates to remove residual soil, detergents, and other undesirable elements that were retained by the articles after completion of the wash cycle. The term “drying cycle” is intended to refer to one or more periods of time in which the dishwashing appliance is operated to dry the articles by removing fluids from the wash chamber. The term “fluid” refers to a liquid used for washing and/or rinsing the articles and is typically made up of water that may include additives such as, e.g., detergent or other treatments.

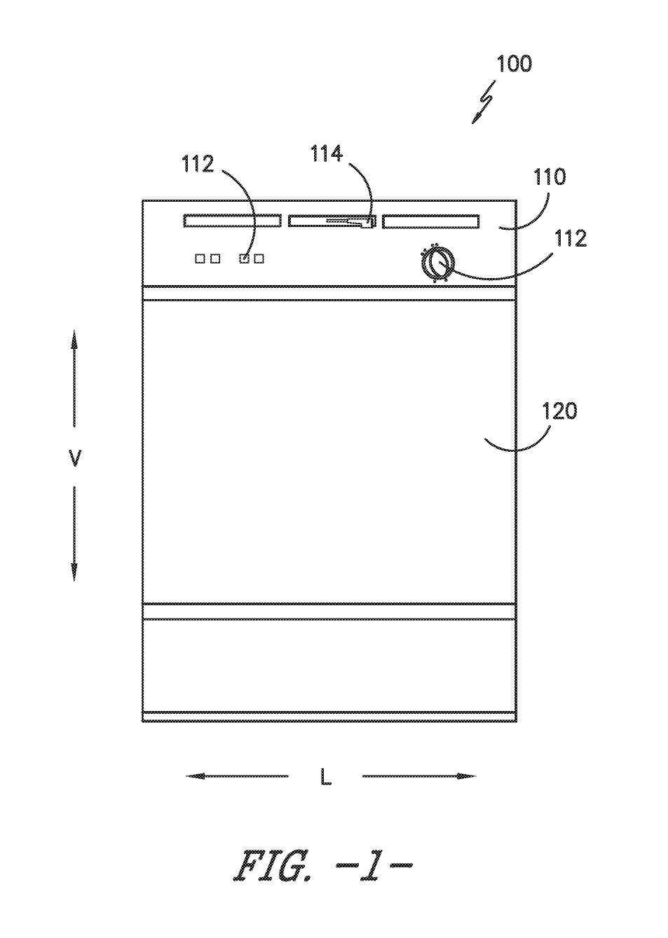

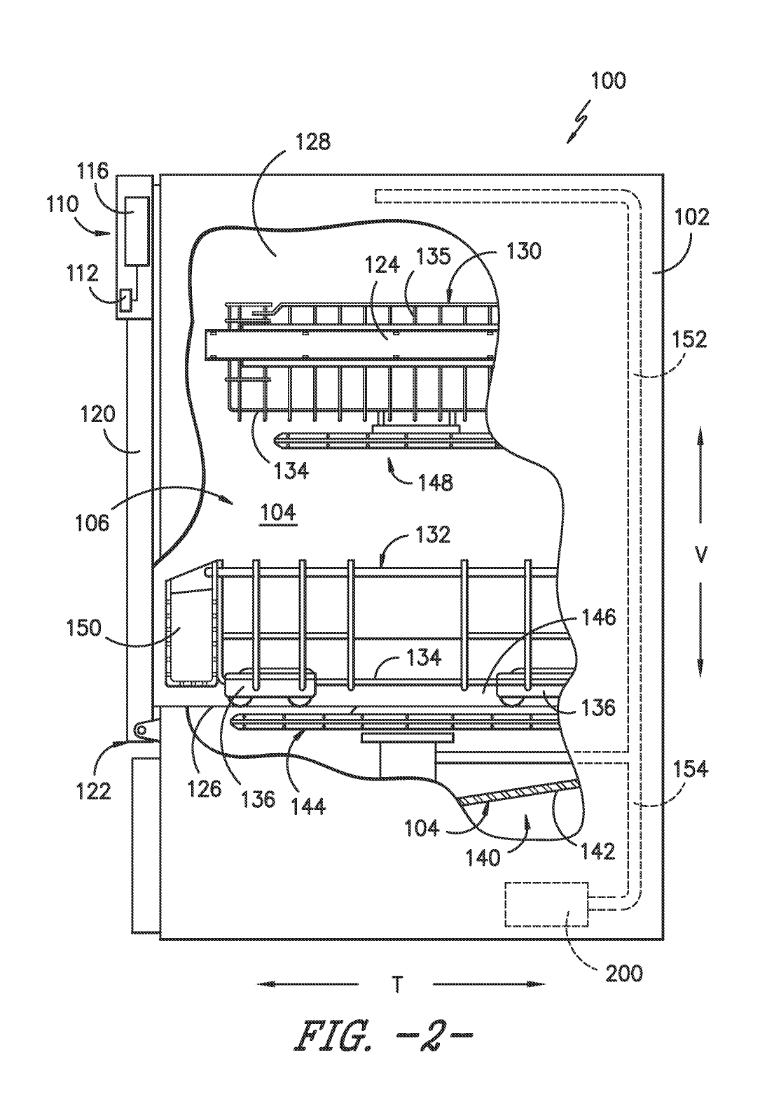

FIGS. 1 and 2 depict a dishwasher appliance 100 according to an exemplary embodiment of the present subject matter. Dishwasher appliance 100 defines a vertical direction V, a lateral direction L (FIG. 1) and a transverse direction T (FIG. 2). The vertical, lateral, and transverse directions V, L, and T are mutually perpendicular and form an orthogonal direction system.

Dishwasher appliance 100 includes a chassis or cabinet 102 having a tub 104. Tub 104 defines a wash chamber 106 and includes a front opening (not shown) and a door 120 hinged at its bottom 122 for movement between a normally closed vertical position (shown in FIGS. 1 and 2), wherein wash chamber 106 is sealed shut for washing operation, and a horizontal open position for loading and unloading of articles from dishwasher appliance 100. A latch 114 is used to lock and unlock door 120 for access to chamber 106.

Slide assemblies 124 are mounted on opposing tub sidewalls 128 to support and provide for movement of an upper rack assembly 130. Lower guides 126 are positioned in opposing manner of the sides of chamber 106 and provide a ridge or shelf for roller assemblies 136 so as to support and provide for movement of a lower rack assembly 132. Each of the upper and lower rack assemblies 130 and 132 is fabricated into lattice structures including a plurality of elongated members 134 and 135 that extend in the lateral L, transverse T, and/or vertical V directions. Each rack assembly 130, 132 is adapted for movement between an extended loading position (not shown) in which the rack is substantially positioned outside the wash chamber 106, and a retracted position (shown in FIGS. 1 and 2) in which the rack is located inside the wash chamber 106. The movement of rack assemblies 130, 132 is facilitated by slide assemblies 124 and roller assemblies 136 that carry the upper and lower rack assemblies 130 and 132, respectively. A basket 150 may be removably attached to the lower rack assembly 132 for placement of silverware, small utensils, and the like, that are too small to be accommodated by the upper and lower rack assemblies 130, 132.

Dishwasher appliance 100 also includes a lower spray assembly 144 that is rotatably mounted within a lower region 146 of the wash chamber 106 and above a tub sump portion 142 so as to rotate in relatively close proximity to lower rack assembly 132. A spray arm or mid-level spray assembly 148 is located in an upper region of the wash chamber 106 and may be located in close proximity to upper rack assembly 130. Additionally, an upper spray assembly (not shown) may be located above the upper rack assembly 130 and mounted to an upper wall of tub 104. Other spray assemblies, such as, e.g., a bottle blaster spray assembly or a silverware wash spray assembly, also may be used.

Each spray assembly includes an arrangement of discharge ports or orifices for directing washing fluid onto dishes or other articles located in upper and lower rack assemblies 130, 132, respectively. The arrangement of the discharge ports in at least the lower spray assembly 144 provides a rotational force by virtue of washing fluid flowing through the discharge ports. The resultant rotation of lower spray assembly 144 provides coverage of dishes and other articles with a washing spray.

Lower and mid-level spray assemblies 144, 148 and the upper spray assembly are fed by a fluid circulation assembly 152 for circulating water and wash fluid in tub 104. Fluid circulation assembly 152 may include a circulation conduit 154 that supplies the fluid to the lower and mid-level spray-arm assemblies 144, 148 and the upper spray assembly 150. Conduit 154 may, for example, be in fluid communication with the sump 142 such that fluid can flow from the sump 142 into conduit 154 as required. Fluid circulation assembly 152 also may include a pump assembly 200 that, along with other portions of the fluid circulation assembly, may be located in a machinery compartment 140 located below tub sump portion 142 of tub 104, as generally recognized in the art. Pump assembly 200 receives fluid from sump 142 and provides a flow of fluid within one or more conduits of fluid circulation assembly. Pump assembly 200 is described in greater detail below.

Dishwasher appliance 100 is further equipped with a controller 116 to regulate operation of dishwasher appliance 100. Controller 116 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 116 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 116 may be positioned in a variety of locations throughout dishwasher appliance 100. In the illustrated embodiment, controller 116 may be located within a control panel area 110 of door 120 as shown. In such an embodiment, input/output (“I/O”) signals may be routed between the control system and various operational components of dishwasher appliance 100 along wiring harnesses that may be routed through bottom 122 of door 120. Typically, the controller 116 includes a user interface panel 112 through which a user may select various operational features and modes and monitor progress of the dishwasher appliance 100. In one embodiment, user interface panel 112 may represent a general purpose I/O (“GPIO”) device or functional block. Further, user interface panel 112 may include input components, such as one or more of a variety of electrical, mechanical or electro-mechanical input devices including rotary dials, push buttons, and touch pads. Additionally, user interface panel 112 may include a display component, such as a digital or analog display device designed to provide operational feedback to a user. User interface panel 112 may be in communication with controller 116 via one or more signal lines or shared communication busses.

It should be appreciated that the present subject matter is not limited to any particular style, model, or configuration of dishwasher appliance. Thus, the exemplary embodiment depicted in FIGS. 1 and 2 is provided for illustrative purposes only. For example, different locations may be provided for user interface 112, different configurations may be provided for upper and lower rack assemblies 130, 132 and/or lower and mid-level spray assemblies 144, 148, and other differences may be applied as well. Additionally or alternatively, one or more pump assemblies may be provided in addition to pump assembly 200 to provide a flow of fluid within tub 104 and/or to drain fluid from tub 104.

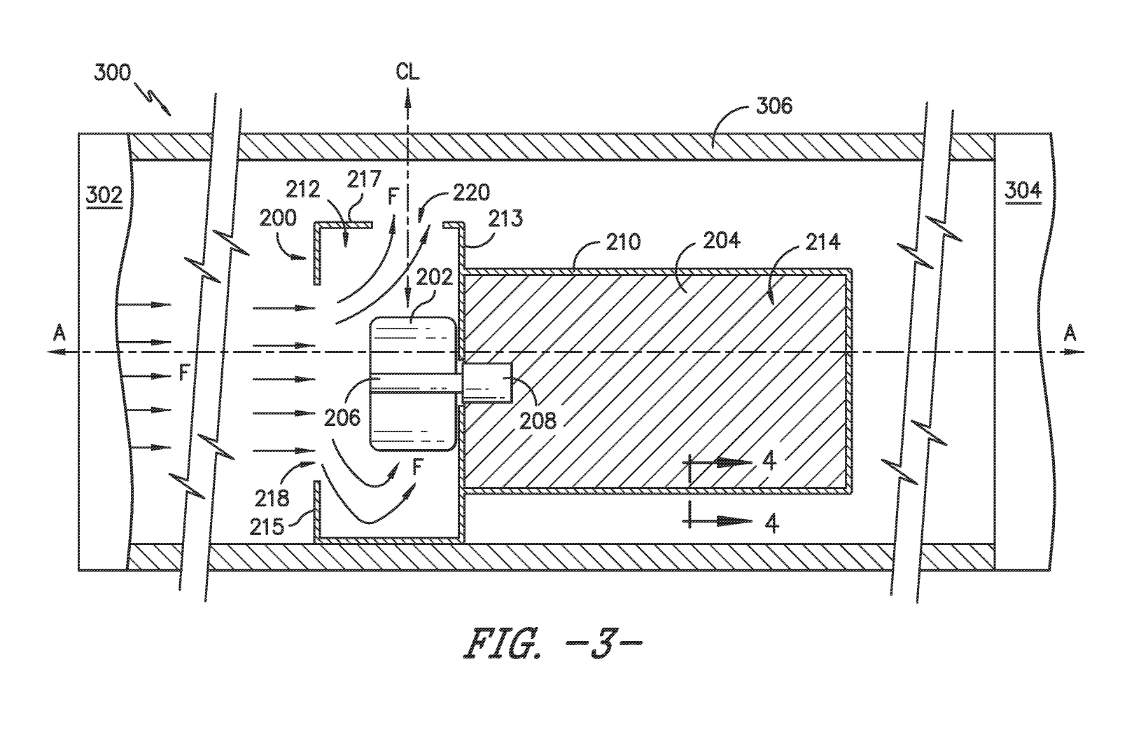

Referring now to FIG. 3, a schematic cross-section view is provided of a pump assembly 200 for use in an appliance 300. In exemplary embodiments, appliance 300 is a dishwasher appliance, such as dishwasher appliance 100. Alternatively, however, any suitable appliance which requires use of a pump to encourage fluid flow therethrough is within the scope and spirit of the present disclosure. For example, washing machines and refrigerators, as well as other suitable appliances, are contemplated.

Appliance 300 may include a fluid source 302. In embodiments wherein the appliance 300 is dishwasher appliance 100, for example, fluid source 302 may be sump 142. Fluid source 302 may provide fluid which may be flowed past components of the pump assembly 200, as discussed herein. Appliance 300 may additionally include a fluid destination 304. In embodiments wherein appliance 300 is dishwasher appliance 100, for example, fluid destination 304 may include one or more spray assemblies, such as lower and mid-level spray-arm assemblies 144, 148 and the upper spray assembly, or may include external plumbing or another suitable drainage location. Fluid destination 304 may be a location to which fluid may flow from fluid source 302 through pump assembly 200. Thus, pump assembly 200 may be in fluid communication with fluid source 302 and fluid destination 304.

Appliance 300 may include a conduit 306 through which fluid may flow. Conduit 306 may be any suitable pipe, hose, etc. in appliance 300 and may be made from a rigid or flexible material. In some exemplary embodiments, for example, conduit 306 may be a circulation conduit, such as circulation conduit 154 of dishwasher appliance 100. In other embodiments, conduit 306 may be a drain conduit. Any suitable conduit through which fluid flows within an appliance is within the scope and spirit of the present disclosure.

As may be seen in FIG. 3, pump assembly 200 includes an impeller 202. Rotation of impeller 202 may generally encourage fluid flow F through conduit 306. Pump assembly 200 also includes a motor 204. Motor 204 is connected to impeller 202 and operable to rotate impeller 202. As shown in FIG. 3, in some embodiments, motor 204 may be disposed within conduit 306, such that fluid flowing within the conduit 306 is flowable around and past motor 204. In other embodiments, only impeller 202 may be disposed within the flow of fluid through conduit 306, i.e., motor 204 may be located external to or outside of conduit 306.

In exemplary embodiments, motor 204 is a low voltage direct current (“DC”) motor. Alternatively, however, other suitable motors, such as high voltage and/or alternating current (“AC”) motors, may be utilized. Additionally, in exemplary embodiments, motor 204 is hermetically sealed or otherwise sealed such that fluid generally cannot enter the interior of motor 204. For example, an outer casing (not shown) of motor 204 may provide such seal.

A shaft 206 may extend between impeller 202 and motor 204 to connect impeller 202 and motor 204. Because shaft 206 may extend through the sealant of motor 204, such as the outer casing, a shaft seal 208 may be disposed between shaft 206 and the sealant of motor 204 to prevent fluid from flowing between the sealant and shaft 206 into the interior of motor 204. Shaft seal 208 may thus maintain the hermetic or other seal of motor 204 in general. Suitable types of shaft seals 208 include, for example, o-rings, mechanical seals, lip seals, and the like.

As will readily be understood, an electrical wire assembly (not shown), which may include for example one or more electrical wires and a sheath surrounding the one or more electrical wires, may extend between and be connected to motor 204 and an external power source (not shown) to power motor 204. The electrical wire assembly may be of any suitable construction and, for example, may use wire seals as necessary generally to maintain the hermetic or other seal of motor 204 and prevent leakage of fluid from conduit 306 into the interior of motor 204. Suitable types of wire seals include, for example, o-rings, potting, etc. Other power connection assemblies, through which motor receives the power it requires to operate, may be used as well.

Together, impeller 202, motor 204, shaft 206, shaft seal 208, and the power connection assembly form the pump of pump assembly 200. As further illustrated in FIG. 3, pump assembly 200 includes a pump housing 210 having an impeller portion 212 and a motor portion 214, each portion 212, 214 defining a cavity. Impeller 202 is disposed within the cavity defined by impeller portion 212 and motor 204 is disposed within the cavity defined by motor portion 214. A shaft opening 216 for the extension of shaft 206 therethrough may be provided in a wall segment 213 extending between impeller portion 212 and motor portion 214. As shown in FIG. 3, pump housing 210 has a unitary construction, i.e., pump housing is integrally formed such that impeller portion 212 and motor portion 214 are a single unit. As such, housing 210 is a unitary pump housing, as further described below.

Further, impeller portion 212 includes an inlet 218 defined in a wall segment 215 of impeller portion 212 and an outlet 220 defined in a wall segment 217 of impeller portion 212. Inlet 218 and outlet 220 place impeller portion 212 of housing 210 in fluid communication with conduit 306. As previously described, the rotation of impeller 202 by motor 204 encourages the flow of fluid F through conduit 306. Thus, inlet 218 provides for the ingress of fluid F from conduit 306 into impeller portion 212 of housing 210, and outlet 220 allows for the egress of fluid F into conduit 306 from impeller portion 212. As shown in FIG. 3, pump housing 210 may be disposed within conduit 306 such that fluid flows into and around housing 210, but in alternative embodiments, only a portion of housing 210 may be disposed within a conduit or a conduit may direct a flow of fluid to inlet 218 and fluid flowing from outlet 220 may flow into a conduit and away from housing 210.

In some embodiments, inlet 218 and outlet 220 may be defined in impeller portion 212 such that conduit 306 is coaxial with inlet 218 and/or outlet 220. In other embodiments, inlet 218 and/or outlet 220 may be defined in impeller portion 212 such that either or both are perpendicular to a longitudinal axis A of conduit 306. For example, in the exemplary embodiment shown in FIG. 3, the centerline CL of outlet 220 is perpendicular to longitudinal axis A of conduit 306. In still other embodiments, e.g., in embodiments in which motor 204 is not disposed within conduit 306, a portion of conduit 306 may extend to inlet 218 and another portion of conduit 306 may extend from outlet 220. In such embodiments, the portion of conduit 306 adjacent inlet 218 may be coaxial with inlet 218 or may be perpendicular to a centerline of inlet 218, and the portion of conduit 306 adjacent outlet 220 may be coaxial with outlet 220 or may be perpendicular to centerline CL outlet 220. Conduit 306 also may have other orientations with respect to inlet 218 and outlet 220, and pump housing 210 may have other configurations with respect to one or more conduits providing a flow of fluid F through housing 210.

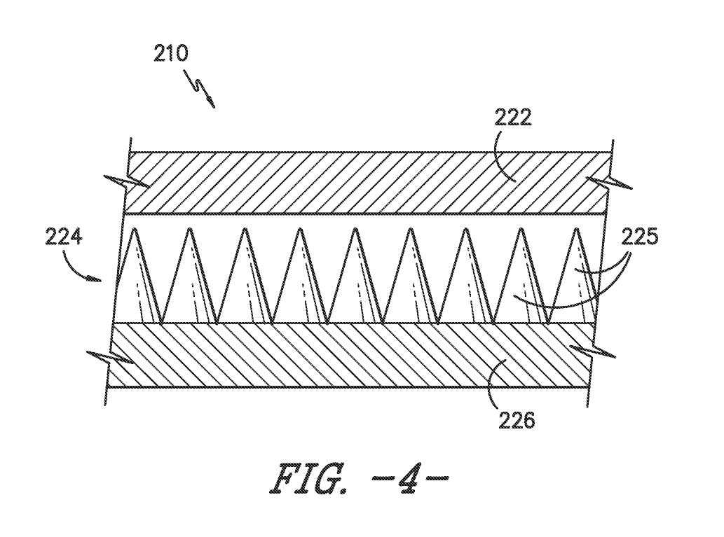

Referring now to FIG. 4, a schematic cross-section view of a portion of pump housing 210 is provided. As illustrated, pump housing 210 is formed from various integral layers and, as such, is a unitary pump housing, i.e., a pump housing having a unitary construction, as further described below. In some embodiments, unitary pump housing 210 may be integrally formed of a structural layer 222 and an acoustic layer 224. For example, acoustic layer 224 may be fused with or printed on top of structural layer 222. In other embodiments, housing 210 may include a sealing layer 226 in addition to structural layer 222 and acoustic layer 224 such that housing 210 is integrally formed of structural layer 222, acoustic layer 224, and sealing layer 226. For example, structural layer 222, acoustic layer 224, and sealing layer 226 may be fused together, or acoustic layer 224 may be printed on top of structural layer 222 and sealing layer 226 printed on top of acoustic layer 224. In still other embodiments, housing 210 may be integrally formed of a plurality of structural, acoustic, and/or sealing layers 222, 224, 226. In such embodiments, the plurality of layers may be constructed consecutively, e.g., a plurality of structural layers 222 may be formed, then a plurality of acoustic layers 224, then a plurality of sealing layers 226. Alternatively, the plurality of layers may be constructed alternately, e.g., one or more structural layers 222 may be formed, followed by one or more acoustic layers 224, then one or more structural layers 222, and then one or more sealing layers 226, or any other pattern of alternating layers may be used. A number and/or pattern of layers 222, 224, and/or 226 may be selected to optimize the noise insulating property or function of unitary pump housing 210, but in each configuration of housing 210, layers 222, 224, and/or 226 are integrally formed of a continuous piece of material such that housing 210 is a single unit, as further described below. Methods for integrally forming housing 210 are further discussed below.

Structural layer 222 is the innermost layer of pump housing 210, formed inward of acoustic layer 224 and adjacent the internal pump components, i.e., between acoustic layer 224 and the internal pump components, e.g., impeller 202 and motor 204. Structural layer 222 may be formed using any material and/or structure suitable for resisting the pressure created by the pump. In some embodiments, structural layer 222 may be a generally flat layer of solid material. In other embodiments, structural layer 222 may be formed of a plurality of elements or segments such that layer 222 is not generally solid.

Acoustic layer 224 is formed outward of structural layer 222 and may be formed from any material and/or structure suitable for isolating or insulating against noise. That is, using acoustic layer 224, pump housing 210 isolates the noise of the pump to reduce the noise heard by a user of appliance 300. In some embodiments, acoustic layer 224 is formed of a noise isolation material, such as a suitable insulation, which absorbs, reflects, and/or attenuates sound waves emanating from the pump. For example, acoustic layer 224 may be formed of a polymer, a plastic, or other material that absorbs, reflects, and/or attenuates sound waves. In other embodiments, acoustic layer 224 is formed using a structure that attenuates noise, such as a plurality of elements 225 shaped to isolate the noise of the pump, e.g., by reflecting sound waves back toward the pump. For example, each element 225 of the plurality of elements forming acoustic layer 224 may be generally wedge- or cone-shaped. As another example, acoustic layer 224 may be formed of a plurality of elements 225 having a plurality of shapes and sizes, each shape configured to isolate noise. In still other embodiments, acoustic layer 224 may be formed of the same material as structural layer 222.

In some embodiments, the plurality of elements 225 may be arranged side-by-side in a uniform configuration, e.g., in parallel rows or columns of evenly spaced elements 225, with each element 225 oriented in the same direction as shown in FIG. 4 or in a pattern of alternating orientations. That is, each element 225 may be oriented in the same direction or in a pattern; for example, in FIG. 4, each element 225 is oriented such that each element 225 increases in cross-section from sealing layer 226 toward structural layer 222. Alternatively, elements 225 may be of various sizes (e.g., various heights, widths, and depths), offset from one another, or arranged in a non-uniform or generally random configuration, e.g., elements 225 may be unevenly spaced such that the plurality of elements 225 does not form rows or columns of elements and/or elements 225 may be arranged in a variety of orientations without an apparent pattern. Acoustic layer 224 may have other configurations and/or structures as well to absorb, reflect, and/or attenuate the noise of the pump.

In some embodiments, pump housing 210 may also include sealing layer 226. Sealing layer 226, formed outward of acoustic layer 224, is a sort of skin or outer layer that seals acoustic layer 224. Sealing layer 226 may be formed using any material and/or structure suitable for sealing the acoustic layer, which, where appropriate, may be the same material used for structural layer 222 and/or acoustic layer 224. In some embodiments, sealing layer 226 may be a generally flat layer of solid material. In other embodiments, sealing layer 226 may be formed of a plurality of elements or segments such that layer 226 is not generally solid. Thus, as described, one layer 222, 224, 226 may be structurally different from another layer 222, 224, 226, and/or the material forming one layer 222, 224, 226 may be physically different from the material forming another layer 222, 224, 226.

As stated, the layers forming pump housing 210 are integrally formed such that pump housing 210 is a unitary pump housing. The term “unitary” as used herein denotes that the associated component, such as pump housing 210 described herein, is made as a single piece during manufacturing. Thus, a unitary component has a monolithic construction for the component and is different from a component that has been made from a plurality of component pieces that have been joined together to form a single component. More specifically with respect to housing 210, although formed from various layers, structural layer 222, acoustic layer 224, and, when provided, sealing layer 226 of housing 210 are of a unitary construction, i.e., constructed as a single unit or piece. Further, as shown in the exemplary embodiment of FIG. 3, unitary pump housing 210 may be integrally formed from layers 222, 224, and 226 to define impeller portion 212 and motor portion 214 of unitary pump housing 210, including wall segments 213, 215, and 217, as a single unit.

In one exemplary embodiment, structural layer 222, acoustic layer 224, and sealing layer 226 may be segments of a single, continuous piece of a polymer, plastic, or other appropriate material forming unitary pump housing 210 having impeller portion 212 and motor portion 214. In another embodiment, housing 210 is formed of a continuous piece of material, where each layer 222, 224, 226 is formed of a different material. That is, although one layer 222, 224, 226 may be formed of a different material than another layer, layers 222, 224, 226 are integrally formed such that the layers are formed of a single, continuous piece, i.e., the different materials are integral. For example, the continuous piece of material may comprise a first material, a second material, and a third material, and structural layer 222 may be formed of the first material, acoustic layer 224 may be formed of the second material, and sealing layer 226 may be formed of the third material. The first, second, and third materials may form a continuous piece of material, e.g., by fusing together layers 222, 224, 226 or by printing one layer on top of another, as further described below. Alternatively, more than one layer may be formed of the same material although the continuous piece of material comprises different materials. As an example, structural layer 222 and sealing layer 226 may be formed of the first material and acoustic layer 224 may be formed of the second material such that structural layer 222, acoustic layer 224, and sealing layer 226 are integrally formed of a continuous piece of material comprising the first material and the second material.

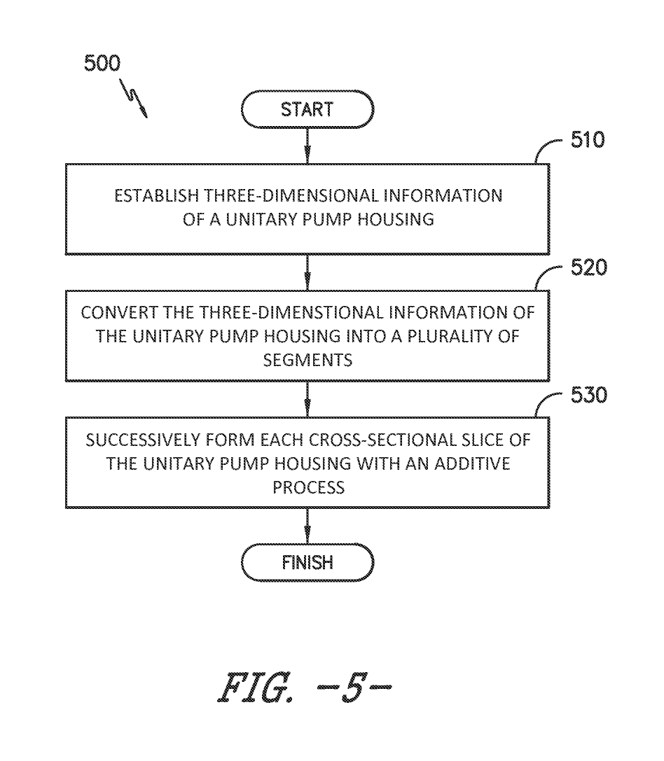

FIG. 5 illustrates a method 500 for forming a unitary pump housing of an appliance according to an exemplary embodiment of the present invention. To achieve a unitary construction, unitary pump housing 210 may be manufactured, fabricated, or formed using an additive process, such as Fused Deposition Modeling (FDM), Selective Laser Sintering (SLS), Stereolithography (SLA), Digital Light Processing (DLP), Direct Metal Laser Sintering (DMLS), Laser Net Shape Manufacturing (LNSM), electron beam sintering, three-dimensional printing, and other known processes. An additive process fabricates plastic or metal components using three-dimensional information, for example a three-dimensional computer model, of the component. The three-dimensional information is converted into a plurality of slices, each slice defining a cross section of the component for a predetermined height of the slice.

Method 500 may be used to form any suitable pump housing, e.g., method 500 may be used to form pump housing 210 as shown in FIGS. 3 and 4. Method 500 permits formation of various features of pump housing 210 and includes fabricating housing 210 as a unitary housing such that, e.g., housing 210 is formed of a continuous piece of plastic, polymer, or other suitable material or combination of materials.

Accordingly, at step 510, three-dimensional information of pump housing 210 is determined. As an example, a model or prototype of housing 210 may be scanned to determine the three-dimensional information of housing 210. As another example, a model of housing 210 may be constructed using a suitable CAD program to determine the three-dimensional information of housing 210. At step 520, the three-dimensional information is converted into a plurality of segments that each define a cross-sectional slice of housing 210. As an example, the three-dimensional information from step 510 may be divided into equal sections or segments, e.g., along a central axis of housing 210 or any other suitable axis. Thus, the three-dimensional information from step 510 may be discretized at step 520, e.g., to provide planar cross-sectional slices of housing 210.

After step 520, housing 210 is fabricated using the additive process, or more specifically each slice is successively formed at step 530, e.g., by fusing or polymerizing a plastic using laser energy or heat. The slices may have any suitable size. For example, each slice may have a size between about five ten-thousandths of an inch and about one thousandths of an inch. Housing 210 may be fabricated using any suitable additive manufacturing machine as step 530. For example, any suitable laser sintering machine, inkjet printer, or laserjet printer may be used at step 530.

Utilizing method 500, housing 210 may have fewer components and/or joints than known pump housings. Specifically, housing 210 may require fewer components because housing 210 may be a single piece of continuous plastic or a polymer, e.g., rather than multiple pieces of plastic and insulation joined or connected together. Also, method 500 may form housing 210 such that acoustic layer 224 is integrally formed within housing 210. Moreover, housing 210 may be less prone to leaks and/or be stronger when formed with method 500.

Various components, facets, features, or portions of housing 210 may be shaped to facilitate building up each successive slice of housing 210 during the additive fabrication process. For example, portions of housing 210 may be designed such that each slice forms a foundation to support the next successive slice. Further, unitary pump housing 210 may be constructed or formed around impeller 202, motor 204, shaft 206, shaft seal 208, and any other components of the pump, such as, e.g., the power connection assembly previously described. For example, using method 500, each segment of housing 210 may be successively formed around the pump components. In other embodiments, pump housing 210 may be formed, e.g., using method 500, and then the various pump components may be installed within pump housing 210.

Accordingly, unitary pump housing 210 may insulate or isolate the noise of the pump of appliance 300 using less insulation material than known insulation techniques. For example, using unitary pump housing 210, the noise of the pump can be isolated to the pump, and the construction of housing 210 can be optimized to insulate against the noise of any given pump. That is, by utilizing an additive manufacturing process to construct unitary housing 210, the optimal structure and material, or an optimal combination of structures and materials, may be selected to absorb, reflect, and/or attenuate the noise of the pump within housing 210 and thereby isolate the pump noise. Thus, utilizing housing 210 in pump assembly 200, the noise does not propagate far from the pump, such that insulation materials are not required for a substantial portion of the appliance to insulate against pump noise. Therefore, the time and expense required to install sound pack materials can be eliminated. In addition, utilizing an additive manufacturing process to form insulated pump housing 210 enables housing 210 to be formed of integrated structures and materials in a way that is not possible through traditional manufacturing techniques.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A pump assembly for an appliance, comprising:
an impeller;
a motor connected to the impeller and operable to rotate the impeller; and
a unitary pump housing including a structural layer and an acoustic layer, the unitary pump housing integrally formed of a continuous piece of material such that the structural layer and the acoustic layer are integrally formed of the continuous piece of material,
wherein the unitary pump housing defines a motor portion surrounding the motor and an impeller portion surrounding the impeller, and
wherein the structural layer is formed inward of the acoustic layer and is adjacent the impeller and motor.

2. The pump assembly of claim 1, wherein the unitary pump housing is constructed using an additive process.

3. The pump assembly of claim 1, wherein the unitary pump housing further comprises a sealing layer integrally formed of the continuous piece of material, wherein the sealing layer is formed outward of the acoustic layer.

4. The pump assembly of claim 1, wherein the acoustic layer is formed of a noise insulating material.

5. The pump assembly of claim 1, wherein the continuous piece of material comprises a first material and a second material, and where the structural layer is formed of the first material and the acoustic layer is formed of the second material.

6. The pump assembly of claim 1, wherein the unitary pump housing is integrally formed of a plurality of structural layers and a plurality of acoustic layers.

7. The pump assembly of claim 1, wherein the structural layer is fused with the acoustic layer.

8. The pump assembly of claim 1, wherein the structural layer and acoustic layer are structurally different.

9. The pump assembly of claim 8, wherein the acoustic layer is a plurality of cone-shaped elements and the structural layer is a solid layer of material.

10. The pump assembly of claim 8, wherein the acoustic layer is a plurality of wedge-shaped elements and the structural layer is a solid layer of material.

11. A method for forming a unitary pump housing of an appliance, comprising:
establishing three-dimensional information of the unitary pump housing;
converting the three-dimensional information of the unitary pump housing from the established three-dimensional information into a plurality of segments, each segment of the plurality of segments defining a respective cross-sectional slice of the unitary pump housing; and
successively forming each cross-sectional slice of the unitary pump housing with an additive process;
wherein, after each cross-sectional slice is successively formed, the unitary pump housing is formed such that (1) the unitary pump housing is integrally formed of a structural layer and an acoustic layer and (2) the unitary pump housing defines a motor portion and an impeller portion.

12. The method of claim 11, wherein the additive process comprises at least one of fused deposition modeling, selective laser sintering, stereolithography, and digital light processing.

13. The method of claim 11, wherein the unitary pump housing is a continuous piece of material after each cross-sectional slice is successively formed.

14. The method of claim 11, wherein the unitary pump housing is integrally formed of a plurality of structural layers and a plurality of acoustic layers.

15. The method of claim 11, wherein the unitary pump housing is integrally formed of a continuous piece of material after each cross-sectional slice is successively formed.

16. The method of claim 11, wherein the unitary pump housing is the structural layer formed of a first material and the acoustic layer formed of a second material, the first material and the second material forming a continuous piece of material.

17. The method of claim 11, wherein the unitary pump housing is integrally formed of the structural layer, the acoustic layer, and a sealing layer after each cross-sectional slice is successively formed, wherein the sealing layer is formed outward of the acoustic layer.

18. The method of claim 17, wherein the unitary pump housing is integrally formed of a plurality of structural layers, a plurality of acoustic layers, and a plurality of sealing layers.

19. The method of claim 11, wherein the acoustic layer is formed of a noise insulating material.

20. The method of claim 11, wherein the acoustic layer is formed of a plurality of elements shaped to attenuate the noise of the pump assembly, the plurality of elements fused with the structural layer to integrally form the unitary pump housing.
